(19) United States
(12) Patent Application Publication
(10) Pub. No.: US 2008/0012266 A1
(43) Pub. Date: Jan. 17, 2008

(54) ATV trailer

(76) Inventor: Steven Earl Lee, Grants Pass, OR (US)

Correspondence Address: LAW OFFICE OF GERALD D. HAYNES, 2 NORTH OAKDALE AVENUE, MEDFORD, OR, 97501, US

(21) Appl. No.: 11/903,101

(22) Filed: Sep. 20, 2007

Related U.S. Application Data
(63) Continuation-in-part of application No. 11/318,302, filed on Dec. 23, 2005.

(51) Int. Cl. B62D 63/06; B62D 47/00

(52) U.S. Cl. 280/424; 280/789

(57) ABSTRACT

An ATV trailer is disclosed. An illustrative embodiment of the ATV trailer includes a portable trailer frame; a tree stand seat having a seat frame detachably carried by the trailer frame, a seat cushion carried by the seat frame and a tree-engaging frame extending from the seat frame; a tree stand frame detachably carried by the trailer frame and having a main frame, at least one seat support member extending from the main frame and at least one seat insertion member extending from the main frame and removably engaging the seat cushion; and a rock shield/foot platform detachably carried by the trailer frame.

### CROSS-REFERENCE TO RELATED APPLICATION

This application is a continuation-in-part of application Ser. No. 11/318,302, filed Dec. 23, 2005 and entitled “ATV Trailer”, which is incorporated by reference herein in its entirety.

### FIELD

The present invention relates to all-terrain vehicles (ATVs). More particularly, the present invention relates to an ATV trailer which can be towed behind an all-terrain vehicle to carry persons and/or supplies, for example.

### BACKGROUND

In recent years, the popularity of all-terrain vehicles (ATVs) has exploded. A typical ATV includes a frame which is mounted on four or six wheels driven by an internal combustion engine. A seat and handlebars are provided on the frame to accommodate a driver and typically at least one passenger who can sit on the seat behind the driver. The ATV may be fitted with various accessories such as a front rack, a rear rack or both front and rear racks to carry supplies such as during a hunting, fishing or camping expedition, or skies for snow mobiles, for example. A typical conventional ATV is suitable for transporting one or two persons as they sit on the seat of the ATV. However, in the event that an injured person must be retrieved from a remote area such as a hunting or camping site, for example, an ATV is typically unsuitable for carrying such a person to a site for medical treatment.

### SUMMARY

The present invention is generally directed to an ATV trailer which can be towed behind an all-terrain vehicle. An illustrative embodiment of the ATV trailer includes a portable trailer frame; a tree stand seat having a seat frame detachably carried by the trailer frame, a seat cushion carried by the seat frame and a tree-engaging frame extending from the seat frame; and a tree stand frame detachably carried by the trailer frame and having a main frame, at least one seat support member extending from the main frame and at least one seat insertion member extending from the main frame and removably engaging the seat cushion; and a rock shield/foot platform detachably carried by said trailer frame.

### BRIEF DESCRIPTION OF THE DRAWINGS

The invention will now be described, by way of example, with reference to the accompanying drawings, in which:

FIG. 1 is a side perspective view of an illustrative embodiment of an ATV trailer according to the present invention, coupled to an ATV;

FIG. 2 is a rear view of an illustrative embodiment of an ATV trailer according to the present invention;

FIG. 3 is a side view of an illustrative embodiment of an ATV trailer according to the present invention, with a stretcher (shown in phantom) supported on the ATV trailer;

FIG. 4 is a top perspective view of a stretcher which can be used in implementation of an ATV trailer according to the present invention;

FIG. 5 is a top view of the stretcher shown in FIG. 4;

FIG. 6 is a side view of the stretcher shown in FIG. 4;

FIG. 7 is a top view of an illustrative embodiment of an ATV trailer according to the present invention, with a stretcher provided on the ATV trailer;

FIG. 8 is a top view of a collapsible stretcher shown in a collapsed or retracted position;

FIG. 9 is a rear view of an alternative illustrative embodiment of the ATV trailer, fitted with a seat which is capable of use as a deer stand;

FIG. 10 is a side view of the ATV trailer illustrated in FIG. 9;

FIG. 11 is an exploded side view of an illustrative embodiment of the ATV trailer, more particularly illustrating an exemplary technique for attaching the seat element to the trailer frame element of the ATV trailer;

FIG. 12 is an exploded rear view of the ATV trailer illustrated in FIG. 11;

FIG. 13 is an exploded side view illustrating an exemplary technique for attaching a tree stand frame to the trailer frame of the ATV trailer;

FIG. 14 is a rear view of a seat element of the ATV trailer illustrated in FIGS. 9-13;

FIG. 15 is a top view of the seat illustrated in FIG. 14;

FIG. 16 is a side view of the seat illustrated in FIG. 14, mounted on a trailer frame (in phantom) of the ATV trailer;

FIG. 17 is a top view, partially in section, of the ATV trailer, with the seat illustrated in FIGS. 14-16 provided on the trailer frame of the ATV trailer;

FIG. 18 is a top view, partially in section, of the ATV trailer, with the seat illustrated in FIGS. 14-16 and the tree stand frame provided on the trailer frame of the ATV trailer;

FIG. 19 is a bottom view of a tree stand frame element of an illustrative embodiment of the ATV trailer;

FIG. 20 is a front view of the tree stand frame;

FIG. 21 is a bottom perspective view of the tree stand frame;

FIG. 22 is a side view of a tree stand of an illustrative embodiment of the ATV trailer, attached to a tree (illustrated in phantom) in typical use;

FIG. 23 is a top perspective view of the tree stand, attached to a tree;

FIG. 24 is an exploded side view of an illustrative embodiment of the ATV trailer, more particularly illustrating attachment of an alternative, standard seat to the trailer frame element of the ATV trailer;

FIG. 25 is an exploded side view of an illustrative embodiment of the ATV trailer, more particularly illustrating attachment of an alternative, handicap seat to the trailer frame element of the ATV trailer;

FIG. 26 is a rear view of an illustrative embodiment of the ATV trailer, more particularly illustrating a leaf spring provided on the trailer frame in place of A-arms (not shown);

FIG. 27 is a side perspective view of an illustrative embodiment of an ATV trailer according to the present invention, coupled to an ATV, more particularly illustrating a brake system provided on the ATV trailer;

FIG. 28 is a rear view of a pair of handlebars, partially in section, fitted with a handbrake; and

FIG. 29 is a rear view of a pair of handlebars, partially in section, fitted with a thumb brake.

### DETAILED DESCRIPTION

Referring to the drawings, an illustrative embodiment of an ATV trailer according to the present invention is generally indicated by reference numeral 1. The ATV trailer 1 is adapted to be coupled to an all-terrain vehicle (ATV) 60, which may be conventional. The ATV 60 typically includes an ATV frame 61 having four, six or eight wheels 62, for example. A chassis 63 and seat 67 are provided on the ATV frame 61. Handlebars 64 are attached to the front wheels 62 for steering of the ATV 60. A hitch bar 65, typically fitted with a hitch ball 66, extends rearwardly from the ATV frame 61, between the rear wheels 62.

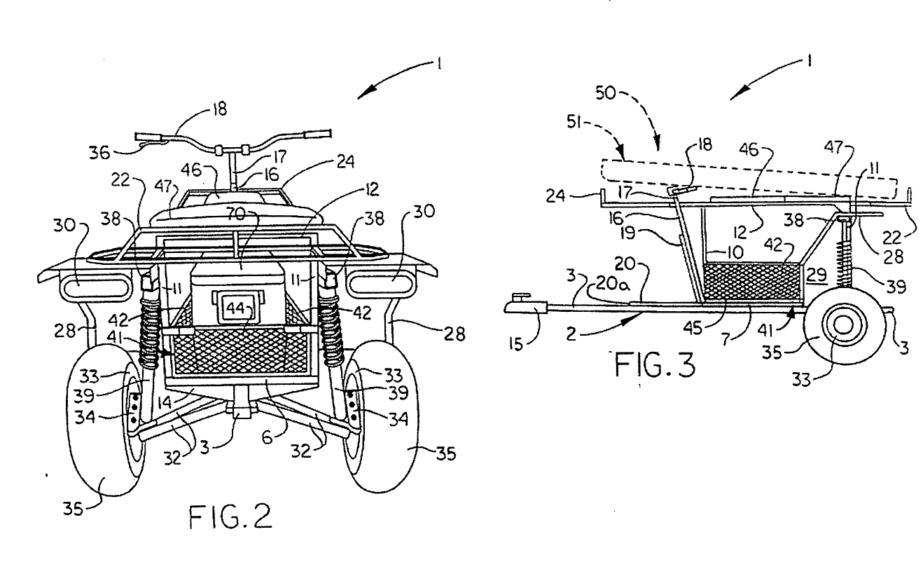

The ATV trailer 1 includes a trailer frame 2 having an elongated trailer tongue 3. A hitch coupling, such as a ball coupling 15, for example, is provided on the forward end of the trailer tongue 2. A front frame member 4 and a middle frame member 5 are typically welded or otherwise attached to the trailer tongue 3, in spaced-apart relationship with respect to each other. As shown in FIG. 2, a rear frame member 6 is further provided on the trailer tongue 3, in spaced-apart relationship to the middle frame member 5. A gusset 14 may be provided between the trailer tongue 3 and rear frame member 6 for reinforcement purposes. The front frame member 4, middle frame member 5 and rear frame member 6 are disposed in generally perpendicular relationship to the trailer tongue 3. A pair of side frame members 7 spans the respective ends of the front frame member 4 and the middle frame member 5. At least one frame stabilizer 8 may span the side frame members 7, between the front frame member 4 and the middle frame member 5. A pair of front frame braces 20 may extend or angle from the respective side frame members 7 and converge toward each other, joining at an apex 20a.

A pair of front vertical frame members 10 extends upwardly from the front frame member 4, in generally parallel, spaced-apart relationship to each other. As shown in FIG. 2, a pair of rear vertical frame members 11 extends upwardly from the rear frame member 6, in generally parallel, spaced-apart relationship to each other. A seat frame 12 is supported by the front vertical frame members 10 and the rear vertical frame members 11. At least one seat is provided on the seat frame 12. For example, a front seat 46 and a rear seat 47, each of which may be padded, may be provided on the seat frame 12. At least one rack may be provided on the trailer frame 2. For example, a rear rack 22 and/or a front rack 24 may be provided on the rear end and/or the front end, respectively, of the seat frame 12.

Handlebars 18 may be provided on the trailer frame 2. A handlebar support member 16 may extend upwardly from the front frame member 4, between the side frame members 7. A handlebar support arm 17 may be adjustably and telescopically extendable from the handlebar support member 16. The handlebars 18 are provided on the handlebar support arm 17. Accordingly, the handlebars 18 may be vertically adjustable by extending or retracting the handlebar support arm 17 in the handlebar support member 16. A rock shield 19 may be provided on the handlebar support member 16.

A pair of wheels 33 is provided on the trailer frame 2. Accordingly, as shown in FIG. 2, a pair of axles 32 extends outwardly and downwardly from each side of the trailer tongue 3. A wheel 33 is rotatably mounted on each pair of axles 32. A brake assembly 34 may be provided on each wheel 33. A brake handle 36 provided on the handlebars 18 or elsewhere on the trailer frame 2 is connected to the brake assemblies 34 to apply braking pressure to the wheels 33. A pneumatic tire 35 is provided on each wheel 33. A shock absorber frame member 38 is welded or otherwise attached to each side of the trailer frame 2, above each axle pair 32. A shock absorber 39 extends between each axle pair 32 and shock absorber frame member 38 on each side of the trailer frame 2. Accordingly, each shock absorber 39 is adapted to absorb shock during towing of the ATV trailer 1 by the ATV 60, which will be hereinafter described.

A pair of wheel fenders 28 may be provided on the trailer frame 2 above the respective wheels 33. Each wheel fender 28 may be welded or otherwise attached to the middle frame member 5, the shock absorber frame member 38 and rear vertical frame member 11, for example, on the corresponding side of the trailer frame 2. An inside fender plate 29 may be welded or otherwise attached to the trailer frame 2, inside each wheel fender 28. At least one light 30 may be provided on the trailer frame 2. For example, lights 30 may be provided on the respective wheel fenders 28 or elsewhere on the rear portion of the trailer frame 2. The lights 30 are connected electrically to lights on the ATV (not shown) or alternatively to a battery (not shown) on the trailer frame 2 and connected to the lights 30. The lights 30 may be connected to the brake handle 36 for illumination of the lights 30 upon application of the brake handle 36. Alternatively, the lights 30 may be independently illuminated using a switch (not illustrated) provided on the handlebars 18 or elsewhere on the trailer frame 2.

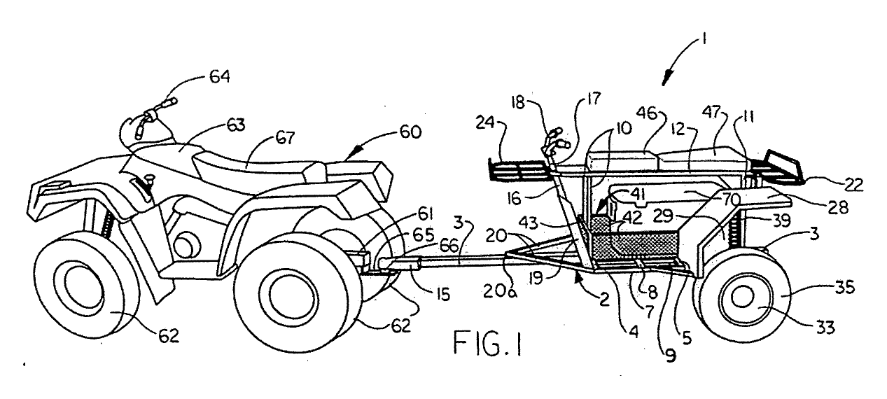

A basket 41 may be provided on the trailer frame 2, beneath the seat frame 12 to carry various supplies or items, such as an ice chest 70, for example. The basket 41 may include a pair of side panels 42, each of which extends between the front vertical frame member 10 and the wheel fender 28 on a corresponding side of the trailer frame 2; a front panel 43 which extends between the side panels 42, as illustrated in FIG. 1; and a rear panel 44 which extends between the rear vertical frame members 11 of the trailer frame 2, as illustrated in FIG. 2. The basket 41 may further include a bottom panel 45 (FIG. 3) which is provided on the trailer frame 2 and extends between the side panels 42 and between the front panel 43 and the rear panel 44. The rear panel 44 may be detachably mounted on the trailer frame 2 to facilitate the placement of items and supplies, such as the ice chest 70, for example, in the basket 41.

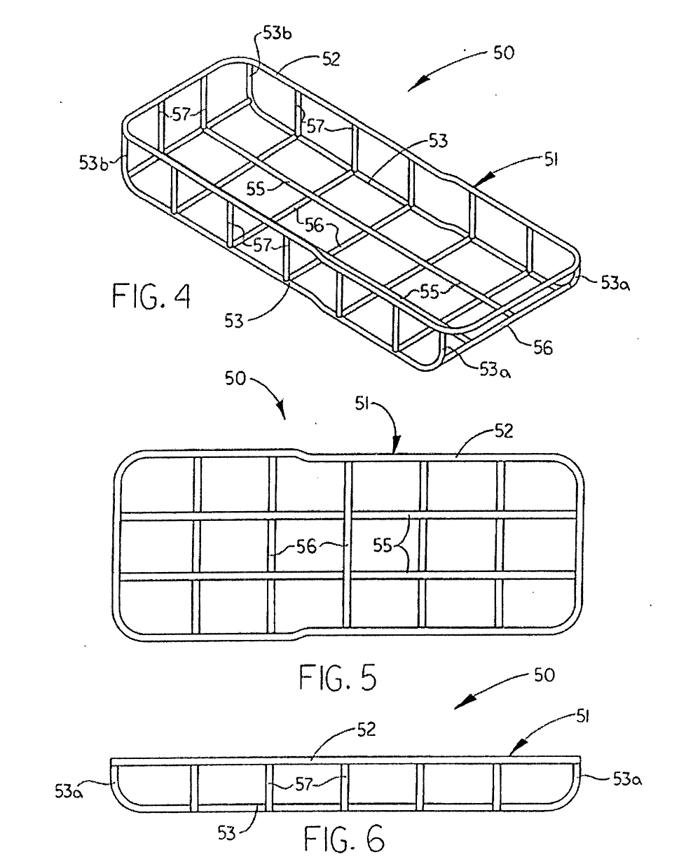

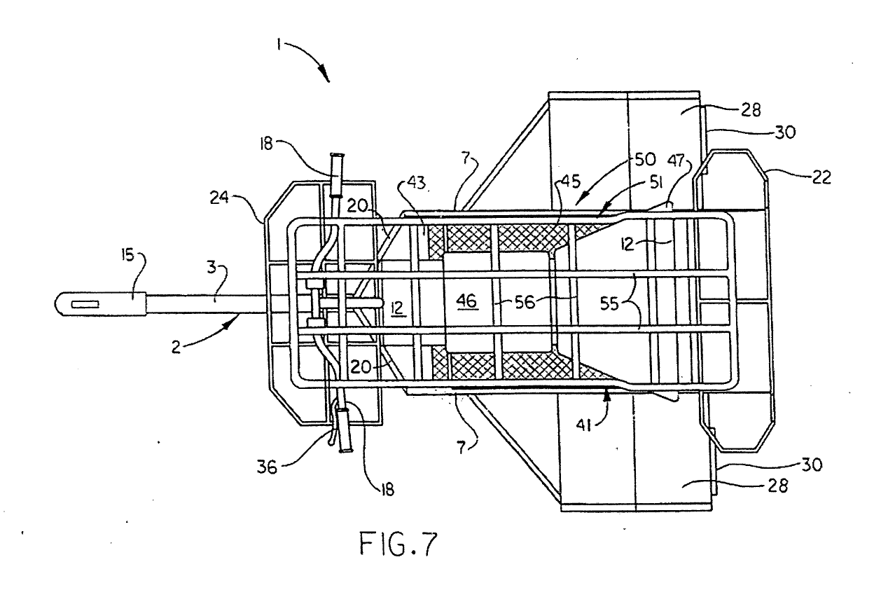

As shown in FIGS. 3 and 7, the ATV trailer 1 may further include a stretcher 50 which can be supported on and attached to the ATV trailer 1 to transport an injured person (not illustrated), as needed. An example of a stretcher 50 which is suitable for the purpose is illustrated in FIGS. 4-6. However, it will be recognized and understood that the stretcher 50 may have a design which departs from that which will be hereinafter described. The stretcher 50 typically includes a stretcher frame 51 having an elongated, generally rectangular top frame member 52. A side frame member 53 is attached to each side of the top frame member 52, typically through a front segment 53a and a rear segment 53b of the side frame member 53. Multiple vertical frame members 57 may span the top frame member 52 and each side frame member 53. Multiple transverse frame braces 56 span the side frame members 53, in spaced-apart relationship to each other. Multiple longitudinal frame braces 55 intersect the transverse frame members 56, in generally parallel, spaced-apart relationship to each other. Vertical frame members 57 may extend between the top frame member 52 and the rearmost of the transverse frame braces 56.

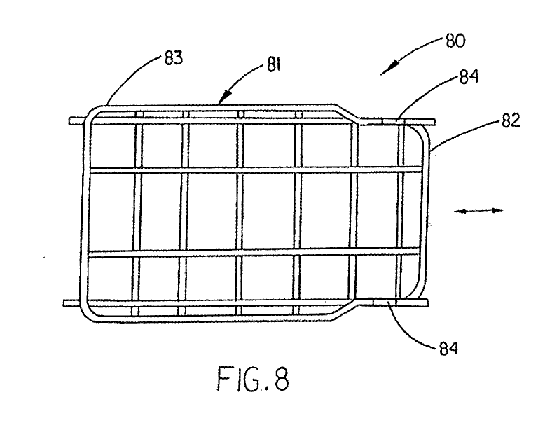

Referring next to FIG. 8, a collapsible stretcher 80 which is suitable for use with the ATV trailer 1 is illustrated. The collapsible stretcher 80 may include, for example, a stretcher frame 81 having a front frame section 82 and a rear frame section 83. A pair of sleeves 84 is provided typically on the rear frame section 83 to facilitate slidable mounting of the front frame section 82 on the rear frame section 83. Accordingly, the collapsible stretcher 80 may be disposed in the collapsed configuration shown in FIG. 8 to facilitate space-efficient storage when not in use. When collapsed, the stretcher 80 may be attached to the ATV frame 61 of the ATV 60 and used as a front rack on the ATV 60, as desired (not illustrated). The front frame section 82 can be slidably extended from the rear frame section 83 to impart an extended, functional configuration to the collapsible stretcher 80 for attachment of the collapsible stretcher 80 to the ATV trailer 1, as needed to transport an injured person, for example. The extended configuration of the collapsible stretcher 80 is similar to the configuration shown with respect to the stretcher 50 of FIGS. 4-6.

In typical use of the ATV trailer 1, the trailer frame 2 is coupled to the ATV 60 typically by hitching the ball coupling 15 on the trailer tongue 3 to the hitch ball 66 on the hitch bar 65 of the ATV 60. Various items or supplies, such as hunting or camping equipment (not shown) or an ice chest 70, for example, may be placed in the basket 41 on the trailer frame 2. This is carried out typically by removing the rear panel 44 from the basket 41, sliding the ice chest 70 or other items or supplies into the basket 41, and replacing the rear panel 4 on the basket 41. Additional items or supplies (not shown) may be fastened on the rear rack 22, the front rack 24, or both the rear rack 22 and the front rack 24. A person (not illustrated) may sit on the front seat 46 or on both the front seat 46 and the rear seat 47 of the ATV trailer 1 as the ATV trailer 1 is towed by the ATV 60. The riding person grips the handlebars 18. As the ATV 60 tows the ATV trailer 1, the shock absorbers 39 absorb shock in the event that the ATV trailer 1 traverses rough terrain, imparting a smooth ride to the person sitting on the ATV trailer 1. The rock shield 19 prevents mud, dirt, rocks and the like from inadvertently striking the items or supplies in the basket 41 and the rider's legs (not illustrated).

It will be appreciated by those skilled in the art that in the event it becomes necessary to retrieve a person who is injured from a remote campsite, hunting area or the like, the stretcher 50 can be supported by and attached to the ATV trailer 1, as illustrated in phantom in FIG. 3 and in top view in FIG. 7. Accordingly, the handlebars 18 are placed in the lowest possible position on the trailer frame 2 by lowering the handlebar support arm 17 in the handlebar support member 16. The injured person is placed in the stretcher 50, which is then supported on the rear seat 47 and the handlebars 18 and attached to the trailer frame 2 using any suitable technique such as bungee cords, clips, hooks, nylon straps or the like. Emergency medical supplies (not illustrated) can be placed in the basket 41. The injured person can then be towed to a suitable medical facility or the like destination by towing the ATV trailer 1 behind the ATV 60. Upon arrival at the destination, the stretcher 50 is detached from the trailer frame 2 and removed from the ATV trailer 1 for treatment of the injured person.

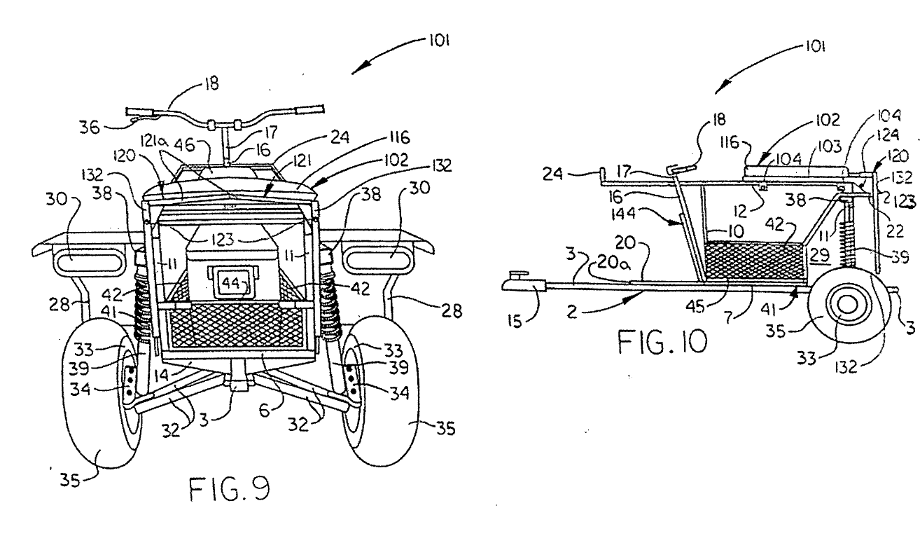

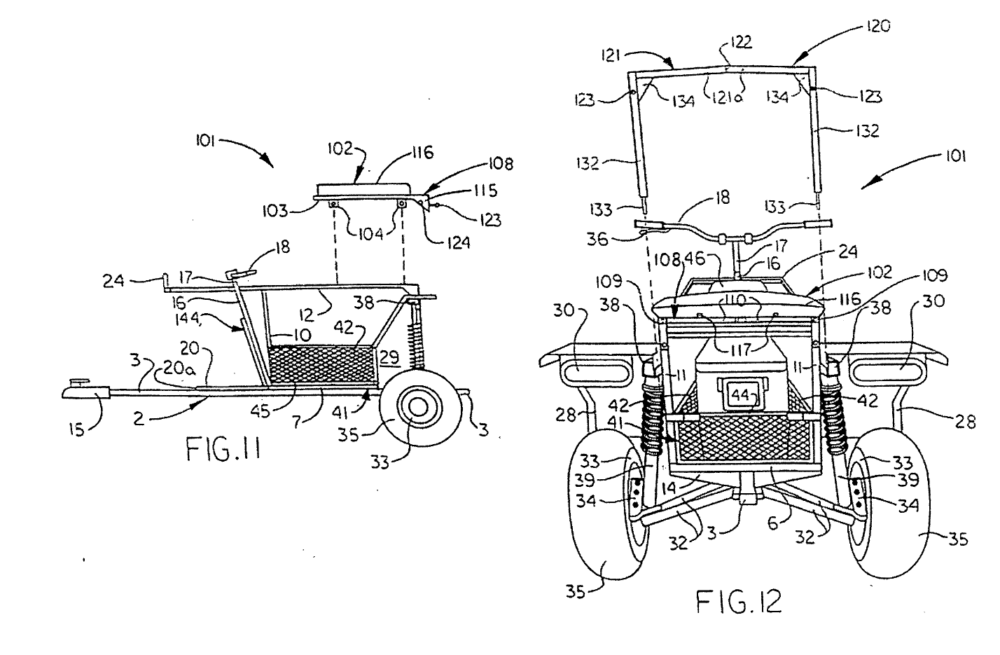

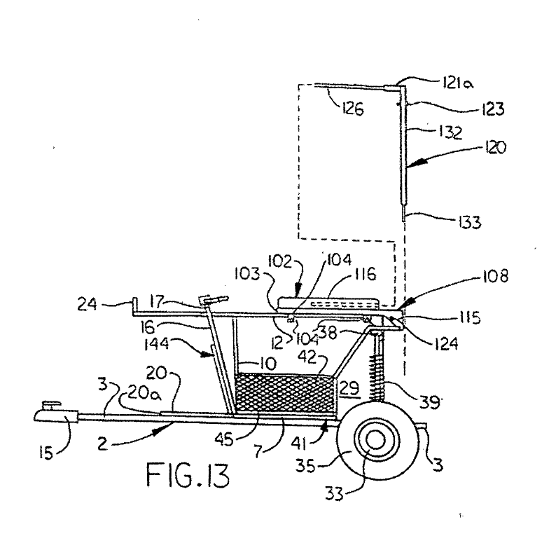

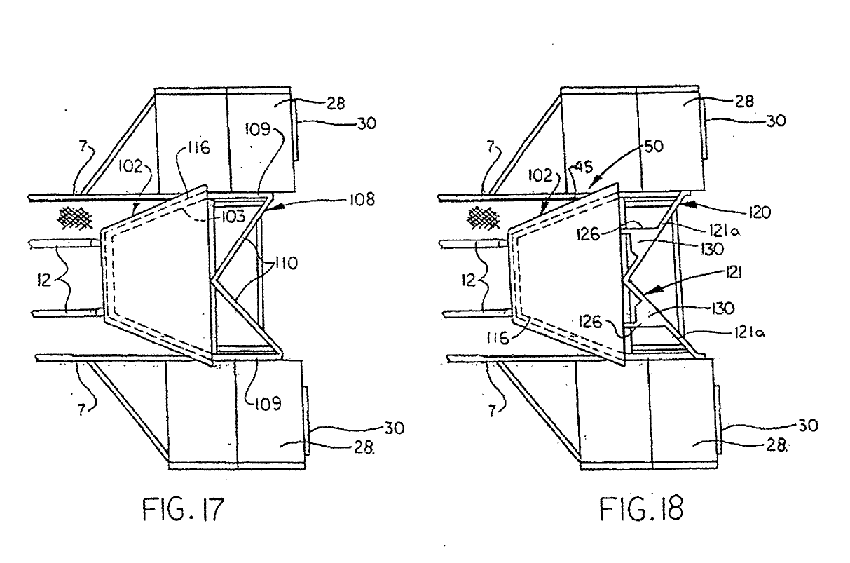

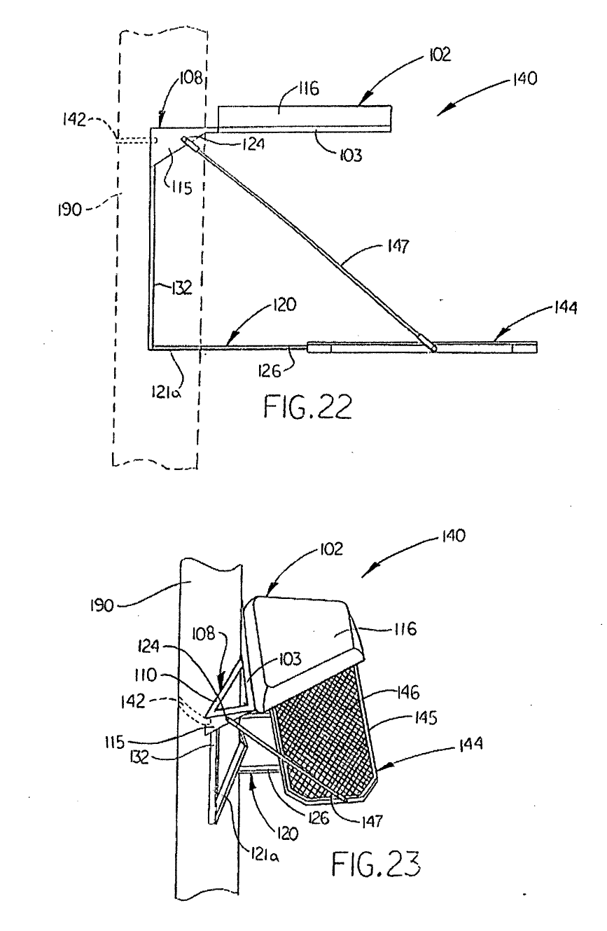

Referring next to FIGS. 9-23 of the drawings, an alternative illustrative embodiment of the ATV trailer is generally indicated by reference numeral 101. The ATV trailer 1 is fitted with a tree stand seat 102 and tree stand frame 120 which can be selectively removed from a transport configuration on the ATV trailer 1 and used as a tree stand 140, as illustrated in FIGS. 22 and 23 and will be hereinafter described. As illustrated in FIGS. 14-16, the tree stand seat 102 includes a seat frame 103 (illustrated in phantom in FIG. 15) which in some embodiments has a generally trapezoidal shape. The tree stand seat 102 is adapted for detachable attachment to the trailer frame 2 of the ATV trailer 101 using any suitable technique which is known by those skilled in the art. In some embodiments, multiple frame attachment flanges 104, each provided with a fastener opening 105, extend from the seat frame 103. Accordingly, as illustrated in FIGS. 9-11 and 17, the tree stand seat 102 is placed on the seat frame 12 of the trailer frame 2. A fastener (not illustrated) is threaded through the fastener opening 105 of each frame attachment flange 104, into a registering fastener opening (not illustrated) in the seat frame 12 or threaded beneath the seat frame 12 to detachably secure the seat frame 103 to the trailer frame 2. However, it is to be understood that alternative techniques known by those skilled in the art may be used for the purpose. A seat cushion 116 is provided on the seat frame 103. As illustrated in FIG. 14, a pair of spaced-apart seat openings 117 extends into one surface of the seat cushion 116. A rock shield 144 may be provided on the handlebar support member 16 or other element of the trailer frame 2. The rock shield 144 is also adapted to be used as a foot platform 144 on a tree stand 140 which is illustrated in FIGS. 22 and 23 and will be hereinafter described. The rock shield 144 can be detachably attached to the handlebar support member 16 or other element of the trailer frame 2 using any suitable technique which is known by those skilled in the art.

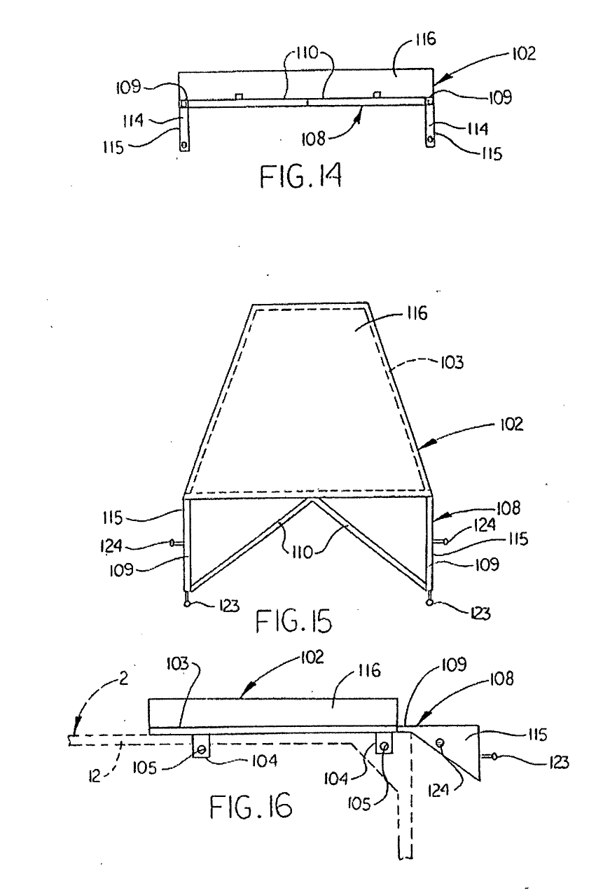

A tree-engaging frame 108 extends from the seat frame 103, adjacent to the surface of the seat cushion 116 into which the pair of seat openings 117 extends. The tree-engaging frame 108 includes a pair of generally parallel, spaced-apart blade support members 109 which extend from the seat frame 103. A pair of tree-engaging blades 110 extends between the distal ends of the respective blade support members 109 and a frame element of the seat frame 103. The tree-engaging blades 110 define a generally V-shaped configuration between the blade support members 109, with the opening of the “V” oriented away from the seat frame 103. As illustrated in FIG. 14, a pair of frame extension members 114 extends from the distal ends of the respective blade support members 109, in generally perpendicular relationship with respect to the respective blade support members 109. As illustrated in FIG. 16, in some embodiments, a generally triangular gusset 115 extends between each blade support member 109 and corresponding frame extension member 114.

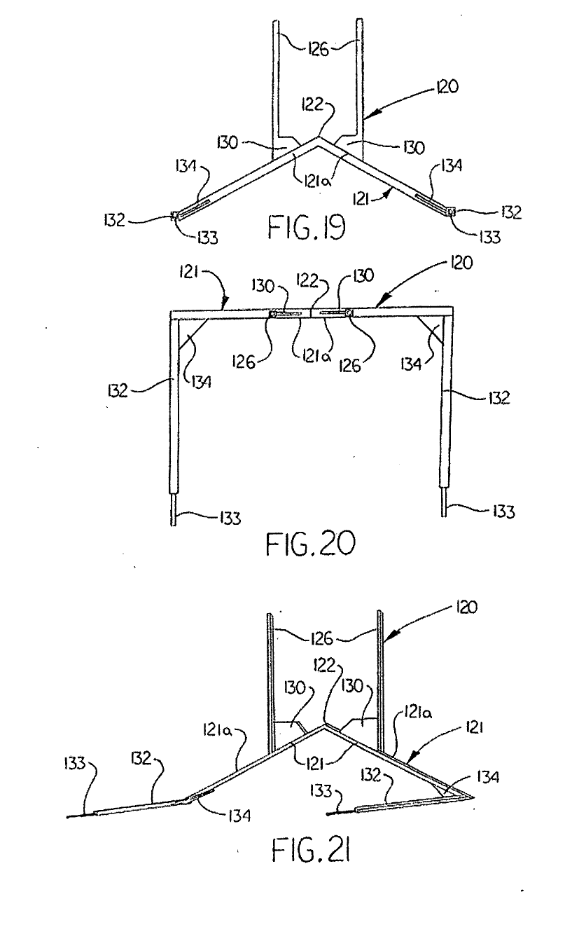

As illustrated in FIGS. 19-21, the tree stand frame 120 includes a tree stand frame 120. The tree stand frame 120 includes a main frame 121 having a pair of main frame members 121a. The main frame members 121a of the main frame 121 are disposed at a generally obtuse angle with respect to each other and define a generally V-shaped configuration. The main frame members 121a of the main frame 121 join at a frame member junction 122. A pair of generally elongated seat insertion members 126 extends from the respective main frame members 121 a of the main frame 121 in generally parallel relationship with respect to each other. Frame gussets 130 may be provided between each seat insertion member 126 and the corresponding main frame member 121a for reinforcement purposes.

A pair of generally elongated seat support members 132 extends from the respective main frame members 121a of the main frame 121, at the distal end of each. As illustrated in FIGS. 20 and 21, the seat support members 132 are disposed in generally parallel relationship with respect to each other and in generally perpendicular relationship with respect to the seat insertion members 126. In some embodiments, an insertion segment 133 extends from each seat support member 132 for purposes which will be hereinafter described. A gusset 134 may extend between each main frame member 121a and the corresponding seat support member 132 for reinforcement purposes. Accordingly, as shown in FIGS. 9, 10, 12, 13 and 18, in the transport configuration, the tree stand frame 120 is attached to the tree stand seat 102 by inserting the seat insertion members 126 of the tree stand frame 120 into the respective seat openings 117 (FIG. 12) provided in the seat cushion 116 of the tree stand seat 102. The seat support members 132 of the tree stand frame 120 extend adjacent to the respective rear vertical frame members 11 of the trailer frame 2. As illustrated in FIG. 10, a frame attachment pin 123 may be provided on each seat support member 132 for attachment to the seat frame 103 of the tree stand seat 102. In some embodiments, the main frame 121 and the seat insertion members 126 are disposed in a common plane. The seat support members 132 are disposed in a plane which is generally perpendicular with respect to the plane of the main frame 121 and the seat insertion members 126.

As illustrated in FIGS. 22 and 23, the tree stand seat 102 and the tree stand frame 120, in conjunction with a foot platform 144 (which also functions as the rock shield 144 provided on the trailer frame 2), can be assembled to form a tree stand 140 which is adapted to engage a tree 190. The foot platform 144 may have any configuration which is suitable for the purpose. As illustrated in FIG. 23, in some embodiments the foot platform 144 has a generally elongated platform frame 145. A platform panel 146 of the foot platform 144 may have a meshwork construction and is provided in the platform frame 145.

The tree stand 140 is assembled by initially removing the rock shield/foot platform 144, tree stand frame 120 and tree stand seat 102 from the trailer frame 2 of the ATV trailer 101. The insertion segments 133 (FIGS. 20 and 21) on the respective seat support members 132 on the main frame 121 of the tree stand frame 120 are inserted into the respective blade support members 109 (FIG. 14) on the tree-engaging frame 108 of the tree stand seat 102. The seat insertion members 126 of the tree stand frame 120 are inserted in respective receptacles (not illustrated) provided on the foot platform 144. In some embodiments, a cable 147 connects the tree-engaging frame 108 and the foot platform 144. Accordingly, the tree-engaging members 110 of the tree-engaging frame 108 and the main frame members 121a of the tree stand frame 120 engage a tree 190, with the tree stand seat 102 disposed above the foot platform 144. A strap 142 is attached to the tree-engaging frame 108 of the tree stand 140 according to the knowledge of those skilled in the art. As illustrated in FIGS. 22 and 23, in some embodiments, the cable 147 is attached to the tree-engaging frame 108 using a pair of cable attachment pins 124. The strap 142 is fastened around the tree 190 and tightened to secure the deer stand 140 on the tree 190. In use, a user (not illustrated) can sit on the seat 102 and rest his or her feet on the footrest 144. The tree stand 140 can be disassembled by unfastening the strap 142; removing the insertion segments 133 on the respective seat support members 132 from the respective blade support members 109 on the tree-engaging frame 108 of the tree stand seat 102; detaching the foot platform 144 from the seat insertion members 126 of the tree stand frame 120; and returning the tree stand seat 102 and tree stand frame 120 to the transport position which was heretofore described with respect to FIGS. 9-13, 17 and 18.

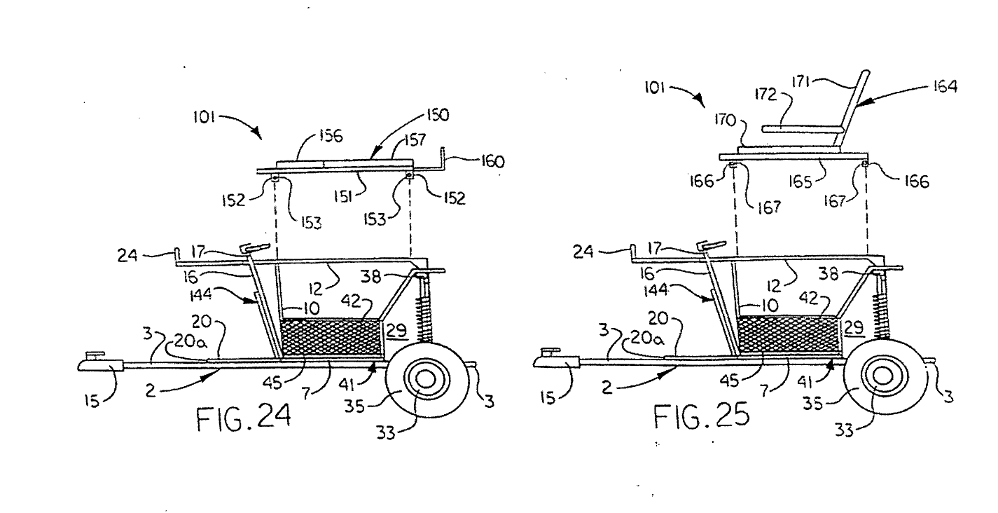

Referring next to FIG. 24, in some embodiments the ATV trailer 101 includes a standard seat 150 which can be attached to the trailer frame 2 interchangeably with the tree stand seat 102. The standard seat 150 includes a standard seat frame 151 which may have a generally elongated, rectangular configuration. At least one seat cushion is provided on the standard seat frame 151. In some embodiments, a front seat cushion 156 and a rear seat cushion 157 are provided on the standard seat frame 151. In other embodiments, a continuous, elongated seat cushion is provided on the standard seat frame 151. In some embodiments, a rack 160 extends rearwardly from the standard seat frame 151.

The standard seat frame 151 of the standard seat 150 may be attached to the seat frame 12 of the trailer frame 2 using any suitable technique which is known by those skilled in the art. For example, in some embodiments multiple frame attachment flanges 152, each provided with a fastener opening 153, extend from the standard seat frame 151. A fastener (not illustrated) is extended through each fastener opening 153 and threaded through a registering fastener opening (not illustrated) provided in the trailer frame 2 or extended beneath the seat frame 12 to detachably secure the standard seat 150 on the seat frame 12.

Referring next to FIG. 25 of the drawings, in some embodiments of the ATV trailer 101, a handicap seat 164 can be attached to the trailer frame 2 interchangeably with the tree stand seat 102 and the standard seat 150. The handicap seat 164 includes a handicap seat frame 165 which may have a generally elongated, rectangular configuration. A seat cushion 170 is provided on the handicap seat frame 165. A backrest 171 extends from the handicap seat frame 165, adjacent to the seat cushion 170. A pair of armrests 172 (one of which is illustrated) may extend from the backrest 171 and/or the seat cushion 170.

The handicap seat frame 165 of the handicap seat 164 may be attached to the seat frame 12 of the trailer frame 2 using any suitable technique which is known by those skilled in the art. For example, in some embodiments multiple frame attachment flanges 166, each provided with a fastener opening 167, extend from the handicap seat frame 165. A fastener (not illustrated) is extended through each fastener opening 167 and threaded through a registering fastener opening (not illustrated) provided in the trailer frame 2 or extended beneath the seat frame 12 to detachably secure the handicap seat 164 on the seat frame 12.

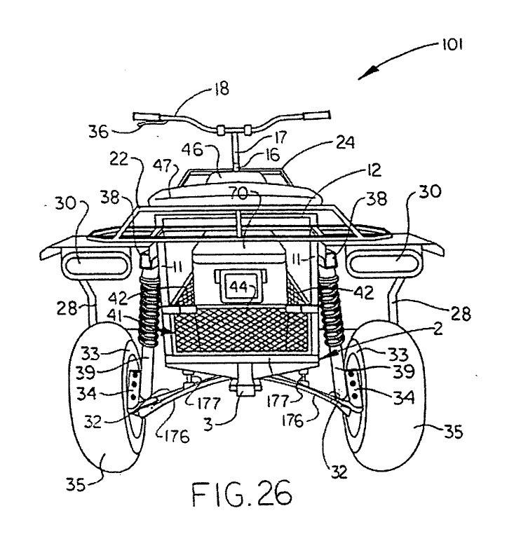

Referring next to FIG. 26 of the drawings, in some embodiments of the ATV trailer 101, leaf springs 176 are provided between the trailer frame 2 and each rear wheel 33 to modify the suspension of the trailer frame 2. Leaf spring supports 177 are interposed between the trailer frame 2 and each set of leaf springs 176. In these embodiments, the leaf springs 176 are used instead of A-arms (not illustrated) to reduce the cost of the ATV trailer 101.

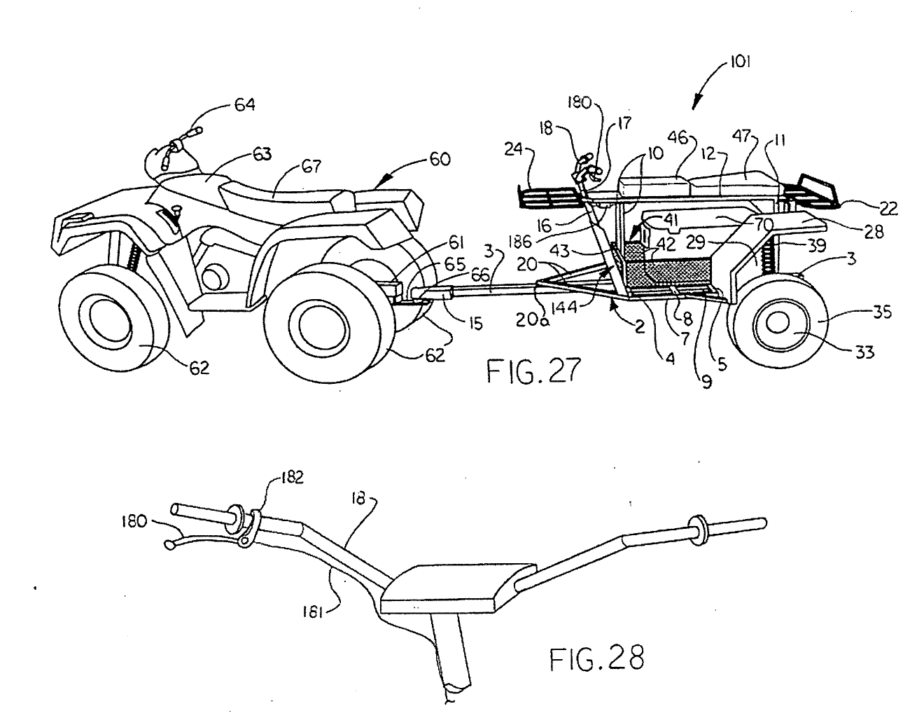

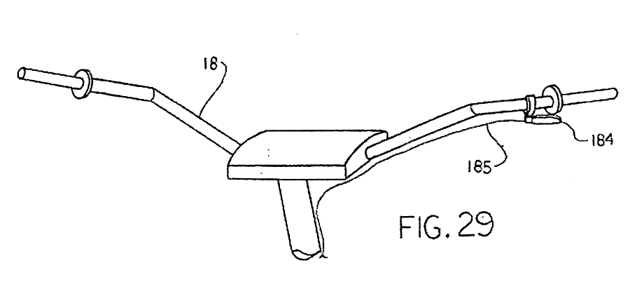

Referring next to FIGS. 27 and 28 of the drawings, in some embodiments of the ATV trailer 101, a handbrake 180 is provided on the handlebars 18. The handbrake 180 is pivotally attached to the handlebars 18 via a handbrake bracket 182. A handbrake cable 181 extends from the handbrake 180 and is routed to a brake controller 186, as illustrated in FIG. 27. The brake controller 186 is provided on any suitable location on the trailer frame 2, such as beneath the seat frame 12, for example. The brake controller 186 is, in turn, connected to the brake assemblies 34 (FIG. 26) and brake lights 30. Accordingly, by actuation of the handbrake 180, the brake controller 186 actuates the brake assembly 34 of each wheel 33 and simultaneously illuminates the brake lights 30. Therefore, the brake controller 186 translates mechanical action of the brake cable 181 into electrical power which powers the brake assemblies 34 and illuminates the brake lights 30. As illustrated in FIG. 29, in some embodiments, a thumb brake 184 is provided on the handlebars 18 in addition to or instead of the handbrake 180. A thumb brake cable 185 connects the thumb brake 184 to the brake controller 186 (FIG. 27). In some embodiments, the handbrake 180 and/or the thumb brake 184 is provided on an ATV 60 which is used to tow the ATV trailer 101.

While the preferred embodiments of the invention have been described above, it will be recognized and understood that various modifications can be made in the invention and the appended claims are intended to cover all such modifications which may fall within the spirit and scope of the invention.

What is claimed is:

1. An ATV trailer, comprising:
a portable trailer frame;
a tree stand seat having a seat frame detachably carried by said trailer frame, a seat cushion carried by said seat frame and a tree-engaging frame extending from said seat frame;
a tree stand frame detachably carried by said trailer frame and having a main frame, at least one seat support member extending from said main frame and at least one seat insertion member extending from said main frame and removably engaging said seat cushion; and
a rock shield/foot platform detachably carried by said trailer frame.

2. The ATV trailer of claim 1 further comprising at least one seat opening provided in said seat cushion and wherein said at least one seat insertion member of said tree stand frame is removably inserted in said at least one seat opening.

3. The ATV trailer of claim 1 wherein said main frame of said tree stand frame comprises a pair of main frame members disposed at a generally obtuse angle with respect to each other.

4. The ATV trailer of claim 3 wherein said at least one seat insertion member comprises a pair of seat insertion members extending from said pair of main frame members, respectively, of said main frame.

5. The ATV trailer of claim 4 further comprising a frame gusset provided between each of said pair of main frame members and a corresponding one of said pair of seat insertion members.

6. The ATV trailer of claim 4 wherein said at least one seat support member comprises a pair of seat support members extending from said pair of main frame members, respectively, of said main frame.

7. The ATV trailer of claim 6 further comprising a pair of insertion segments extending from said pair of seat support members, respectively.

8. The ATV trailer of claim 1 wherein said seat frame of said tree stand seat has a generally trapezoidal configuration.

9. An ATV trailer, comprising:
a portable trailer frame;
a tree stand seat having a seat frame detachably carried by said trailer frame, a seat cushion carried by said seat frame and a tree-engaging frame extending from said seat frame;
a tree stand frame detachably carried by said trailer frame and having a main frame, at least one seat support member extending from said main frame and at least one seat insertion member extending from said main frame and removably engaging said seat cushion; and
at least one of a standard seat and a handicap seat adapted for attachment to said trailer frame interchangeably with said tree stand seat.

10. The ATV trailer of claim 9 further comprising at least one seat opening provided in said seat cushion and wherein said at least one seat insertion member of said tree stand frame is removably inserted in said at least one seat opening.

11. The ATV trailer of claim 9 wherein said main frame of said tree stand frame comprises a pair of main frame members disposed at a generally obtuse angle with respect to each other.

12. The ATV trailer of claim 11 wherein said at least one seat insertion member comprises a pair of seat insertion members extending from said pair of main frame members, respectively, of said main frame.

13. The ATV trailer of claim 12 wherein said pair of seat insertion members is disposed in generally perpendicular relationship with respect to said main frame and said at least one seat support member.

14. The ATV trailer of claim 13 wherein said at least one seat support member comprises a pair of seat support members extending from said pair of main frame members, respectively, of said main frame.

15. The ATV trailer of claim 14 further comprising a pair of insertion segments extending from said pair of seat support members, respectively.

16. The ATV trailer of claim 9 wherein said seat frame of said tree stand seat has a generally trapezoidal configuration.

17. An ATV trailer, comprising:
a portable trailer frame having a plurality of wheels;
a tree stand seat having a seat frame detachably carried by said trailer frame, a seat cushion carried by said seat frame and a tree-engaging frame extending from said seat frame;
a tree stand frame detachably carried by said trailer frame and having a main frame, at least one seat support member extending from said main frame and at least one seat insertion member extending from said main frame and removably engaging said seat cushion;
a rock shield/foot platform detachably carried by said trailer frame;
a brake assembly engaging at least two of said plurality of wheels;
a brake controller connected to said brake assembly;
at least one of a handbrake and a thumb brake connected to said brake controller;
at least one brake light connected to said brake controller; and
wherein said brake controller is adapted to translate mechanical brake power from said at least one of a handbrake and a thumb brake into electrical power for said brake assembly and said at least one brake light.

18. The ATV trailer of claim 17 wherein said main frame of said tree stand frame comprises a pair of main frame members disposed at a generally obtuse angle with respect to each other and wherein said at least one seat insertion member comprises a pair of generally parallel, spaced-apart seat insertion members extending from said pair of main frame members, respectively, and said at least one seat support member comprises a pair of seat support members extending from said pair of main frame members, respectively.

19. The ATV trailer of claim 18 wherein said pair of seat support members is disposed in generally perpendicular relationship with respect to said pair of seat insertion members.

20. The ATV trailer of claim 17 further comprising leaf springs interposed between each of at least two of said plurality of wheels and said trailer frame and at least one leaf spring support interposed between said trailer frame and each of said leaf springs, respectively.
